(19) United States
(12) Patent Application Publication
(10) Pub. No.: US 2012/0263252 A1
(43) Pub. Date: Oct. 18, 2012

(54) Systems and Methods of Power Line Transmission of Solar Panel Data

(75) Inventor: Sriram Narayanan, Richardson, TX (US)

(73) Assignee: Texas Instruments Incorporated, Dallas, TX (US)

(21) Appl. No.: 13/084,553

(22) Filed: Apr. 12, 2011

(51) Int. Cl. H04L 1/02

(52) U.S. Cl. 375/267

(57) ABSTRACT

Statistical analysis may be requested for a solar panel system. Each section of the panel may be assigned to a particular slice of an OFDM transmission scheme. The photovoltaic (PV) modules are divided into strings of modules and a spectrum of frequencies is divided into sub-channels. Then each string is assigned into a timeslot data related PV modules is transmitted on a particular sub-channel during the assigned timeslot.

### TECHNICAL FIELD

The present disclosure is generally related to data transmission and, more particularly, is related to power line data transmission.

### BACKGROUND

A photovoltaic (PV) array (also called a solar array) is a linked collection of photovoltaic modules, which are in turn made of multiple interconnected solar cells. By their modularity, they are able to be configured to supply most loads. The cells convert solar energy into direct current electricity via the photovoltaic effect. The power that one module can produce is seldom enough to meet requirements of a home or a business, so the modules are linked together to form an array. Most PV arrays use an inverter to convert the DC power produced by the modules into alternating current that can plug into the existing infrastructure to power lights, motors, and other loads. The modules in a PV array are usually first connected in series to obtain the desired voltage; the individual strings are then connected in parallel to allow the system to produce more current. In urban and suburban areas, photovoltaic arrays are commonly used on rooftops to supplement power use; often the building will have a connection to the power grid, in which case the energy produced by the PV array can be sold back to the utility in some sort of net metering agreement.

At high noon on a cloudless day at the equator, the solar irradiance can get up to 1.6 kW/m² or higher, on the Earth's surface, to a plane that is perpendicular to the sun's rays. As such, PV arrays can track the sun through each day to greatly enhance energy collection. However, tracking devices add cost, and require maintenance, so it is more common for PV arrays to have fixed mounts that tilt the array and face due South in the Northern Hemisphere (in the Southern Hemisphere, they should point due North). The tilt angle, from horizontal, can be varied for season, but if fixed, should be set to give optimal array output during the peak electrical demand portion of a typical year.

Trackers and sensors to optimize the performance are often seen as optional, but tracking systems can increase viable output by up to 100%. PV arrays that approach or exceed one megawatt often use solar trackers. Accounting for clouds, and the fact that most of the world is not on the equator, and that the sun sets in the evening, the correct measure of solar power is insolation—the average number of kilowatt-hours per square meter per day. For the weather and latitudes of the United States and Europe, typical insolation ranges from 4 kWh/m²/day in northern climes to 6.5 kWh/m²/day in the sunniest regions.

In 2010, solar panels available for consumers can have a yield of up to 19%, while commercially available panels can go as far as 27%. Thus, a photovoltaic installation in the southern latitudes of Europe or the United States may expect to produce 1 kWh/m²/day. A typical “150 watt” solar panel is about a square meter in size. Such a panel may be expected to produce 1 kWh every day, on average, after taking into account the weather and the latitude.

In the Sahara desert, with less cloud cover and a better solar angle, one can obtain closer to 8.3 kWh/m²/day. The unpopulated area of the Sahara desert is over 9 million km², which if covered with solar panels would provide 630 terawatts total power. The Earth's current energy consumption rate is around 13.5 terawatts (TW) at any given moment (including oil, gas, coal, nuclear, and hydroelectric).

Other factors affect PV performance. The electrical output of many PV cells may be sensitive to shading. Some modules have bypass diodes between each cell or string of cells that minimize the effects of shading and only lose the power of the shaded portion of the array (The main job of the bypass diode is to eliminate hot spots that form on cells that can cause further damage to the array, and cause fires.). When even a small portion of a cell, module, or array is shaded, while the remainder is in sunlight, the output falls dramatically due to internal ‘short-circuiting’ (the electrons reversing course through the shaded portion of the p-n junction). Therefore it is extremely important that a PV installation is not shaded at all by trees, architectural features, flag poles, or other obstructions like continuously parked cars. Sunlight can be absorbed by dust, fallout, or other impurities at the surface of the module. This can cut down the amount of light that actually strikes the cells by as much as half. Maintaining a clean module surface will increase output performance over the life of the module. Module output and life are also degraded by increased temperature. Allowing ambient air to flow over, and if possible behind, PV modules reduces this problem.

### SUMMARY

Example embodiments of the present disclosure provide systems of power line transmission of solar panel data. Briefly described, in architecture, one example embodiment of the system, among others, can be implemented as follows: a plurality of photovoltaic (PV) modules configured into at least one string of modules, each string of modules assigned to a timeslot in a transmission scheme, each module of each string of modules assigned to a sub-channel in a spectrum of frequencies; and at least one modem configured to communicate data related to at least on of the modules of the plurality of PV modules on a power line.

Embodiments of the present disclosure can also be viewed as providing methods for power line transmission of solar panel data. In this regard, one embodiment of such a method, among others, can be broadly summarized by the following steps: dividing a plurality of photovoltaic (PV) modules into at least one string of modules; dividing a spectrum of frequencies into sub-channels; and assigning each string into a timeslot; and sending data related to at least one of the plurality of PV modules on a sub-channel during the assigned timeslot.

### BRIEF DESCRIPTION OF THE DRAWINGS

FIG. 1 is a system diagram of an example embodiment of a photovoltaic cell.

FIG. 2 is a system block diagram of an example embodiment of a photovoltaic module array.

FIG. 3 is a system block diagram of an example embodiment of a system of power line transmission of solar panel data.

FIG. 4 is a flow diagram of an example embodiment of a method of power line transmission of solar panel data.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Solar panels are often installed in places such as rooftops that are not easily accessible. This creates a need to gather information regarding the health of the solar panels at a base station that is easily accessible and is connected to the Internet. The power line used to deliver solar power acts a natural medium to carry data gathered from the solar panels.

An important consideration for solar networks is that multiple panels are able to synchronously communicate information since the environmental parameters—insolation, cloud cover, and others—vary with time and affect performance of solar panels. The systems and methods of power line solar panel data transmission disclosed herein allow for simultaneous gathering of information from panels at a central base station.

Orthogonal frequency division multiplexing (OFDM) is presently a popular choice for communication over power lines. The systems and methods of power line transmission of solar panel data disclosed herein address the solar application by presenting a way for OFDM modems to communicate synchronously by sharing the available spectrum among the different panels.

In an example application, a large number of solar panels are installed in a remote location, for instance, a rooftop, and a user requests an update of information on the electrical properties of each of the panels. The electrical properties of each panel may include as non-limiting examples the operating voltage, the current that is generated by the solar cell, and physical parameters including the amount of incoming solar radiation, and the temperature. The physical parameters may affect the amount of current that the solar cell generates. A large number of solar modules may be connected in series in a particular application. If any particular one is underperforming, then a technician may, for example, undergo a debugging effort to determine which cell is not operating at acceptable efficiency. In absence of the communications, the technician would have to go up on the rooftop and inspect each PV cell until he found which one was at fault. This could be expensive and difficult as well as dangerous in some instances.

Customers may expect a certain amount of power generation from the solar installation. The power generated may vary based on the weather conditions, what kind of shade, if leaves fall on the panels, etc. that will affect the amount of power generated. Customers may expect the installer or utility company to justify the amount of power generation. If the solar panel array is not operating at expected efficiency, log data from the solar panels may be examined to determine reasons. Given environmental conditions, the amount of current generated by a solar panel is directly dictated by physics. So it may depend on the amount of incoming radiation, but the efficiency may also vary with temperature, for instance. It would be desirable to be able to simultaneously compare how the different panels in a given string are performing. These factors or parameters could change significantly. Cloud cover could quickly affect the output of the panels, which could change the current that comes out of the solar panel string.

In an ideal world, this information would be accessible instantaneously. A user may request the electrical properties of each of these solar cells. Previous solutions for transmitting the data have included RF wireless transmission to transmit information from the solar panels down to some kind of logger or data repository. A potential problem with RF transmission is that the wireless communication is often intermittent and synchronization of the transmission of the data may be difficult. Moreover, the additional wireless infrastructure comes at a significant extra cost. The systems and methods of power line solar panel data transmission disclosed herein piggyback the information on the existing power lines. OFDM is a technique in which the available spectrum is divided into different sub-bands and information is then modulated on the different orthogonal frequency bands. The information is then demodulated on the other end.

One of the approaches that is currently being adopted in power line communication standards is called the prime standard, in which OFDM is used to break down a portion of frequency spectrum into smaller bands. This enables the elimination or reduction of frequency dependent distortion that occurs over the wide band. So if a 50 kHz band, for example, of the frequency spectrum is selected, there may be some frequency dependant distortion at different points in the band. However, if the spectrum is sliced up into small enough sub-bands, the frequency response remains fairly flat within a sub-band.

The data rate for a solar application is relatively small. Example data categories include non-limiting examples of solar radiation, temperature, solar wind tilt, etc. So there is not a large amount of data. For a solar system with a thousand panels, for example, statistical analysis may be performed substantially instantaneously with all of the data. To do that, a subset of carriers may be allocated to the panels at installation. Once a solar panel is installed, the solar panel is there for a long time, up to twenty or twenty-five years. So there is not a lot of adapting to different networks or adding and deleting entities from the network. Each section of the panel may be assigned to a particular slice of the OFDM transmission scheme; such a scheme is often termed OFDMA, orthogonal frequency division multiple access. By applying OFDMA to a solar application, spectral efficiency and data integrity may be maintained.

The power electronics may introduce a significant amount of noise onto the power line, so different frequency bands are affected differently from the switching of the power electronics. In one example embodiment, a DC/DC converter is used to convert the data from one DC voltage to a different DC voltage that may be shifted up a little bit. Other power electronics may include a DC/AC inverter to convert the DC voltage to an AC voltage that can be modulated onto the grid. The power electronics adds noise to the grid. An example embodiment of the systems and methods power line transmission of solar panel data disclosed herein takes a 125 kilohertz of bandwidth and divides the 125 kilohertz into 16 different channels for the 16 panels in an example string. Each channel is allocated to a particular panel and each sub-channel has multiple sub-carriers. The allocation may be performed upon panel installation. Using this method, each panel of a given string is able to superimpose its communication onto the communications of the other panels. The base station may be positioned in an accessible space upon installation of the panels. In an example embodiment, the base station is tasked with the assignment of each panel to a sub-channel.

Even though the panels are superimposing communication signals, the base station is able to demodulate the signals and produce the data relative to each panel. In an example embodiment, a static allocation is performed, In an example allocation, one channel is split up into, for example, 3 channels. However, environmental conditions may affect the spectrum of frequencies causing interference with the sub-channels. In an alternative embodiment, instead of performing a static allocation, a dynamic allocation may be implemented in which the base station may modify the allocation of the sub-channels. If one of the sub-channels is determined to be noisy, the base station, may switch the allocation to different sub-channels. This implementation could alleviate wasted energy due to poor communication.

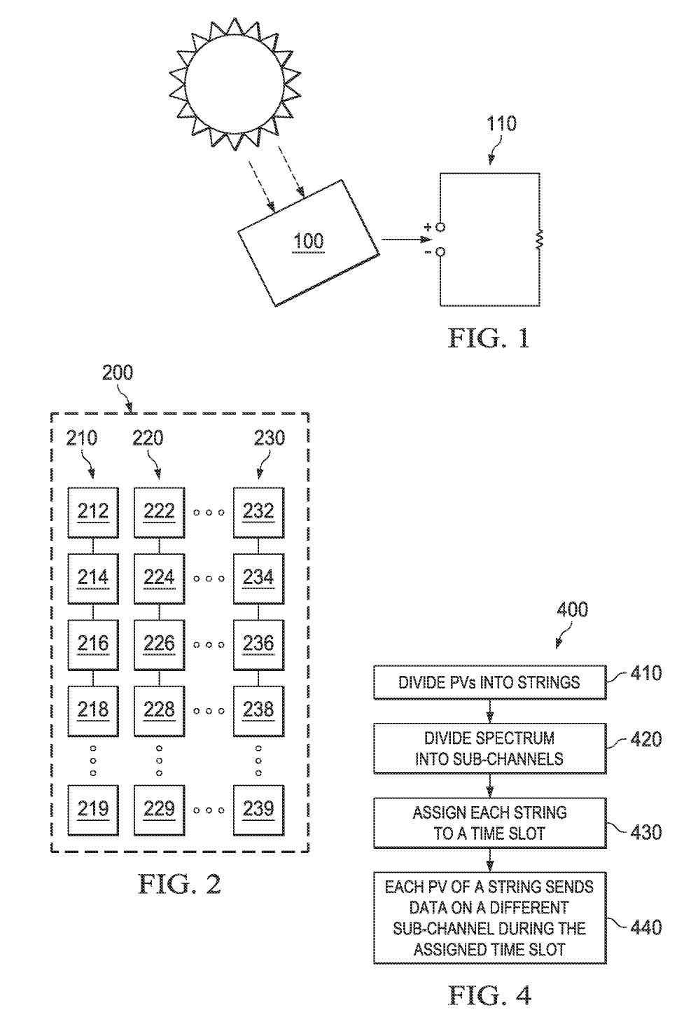

FIG. 1 is a system diagram of a photovoltaic cell operation, in which photovoltaic cell 100 receives sunlight from an illumination source, for example, the sun. PV cell 100 converts the light source energy into electrical energy, which is modeled by circuit 110. Photons in sunlight hit the solar panel and are absorbed by semiconducting materials, such as silicon. Electrons (negatively charged) are knocked loose from their atoms, allowing them to flow through the material to produce electricity. Due to the special composition of solar cells, the electrons are only allowed to move in a single direction. An array of solar cells converts solar energy into a usable amount of direct current (DC) electricity.

FIG. 2 is a system block diagram of photovoltaic module array 200 that has been divided into strings 210, 220 and 230. String 210 is comprised in this example embodiment of PV modules 212, 214, 216, 218 and 219. String 220 comprises PV modules 222, 224, 226, 228 and 229. String 230 is comprised of PV modules 232, 234, 236, 238 and 239. In an example embodiment of the systems and methods of power line transmission of solar panel data, each string is assigned to a timeslot in an OFDM scheme. A spectrum of frequencies is divided into sub-channels and data related to a particular module is sent on a particular sub-channel during the assigned timeslot.

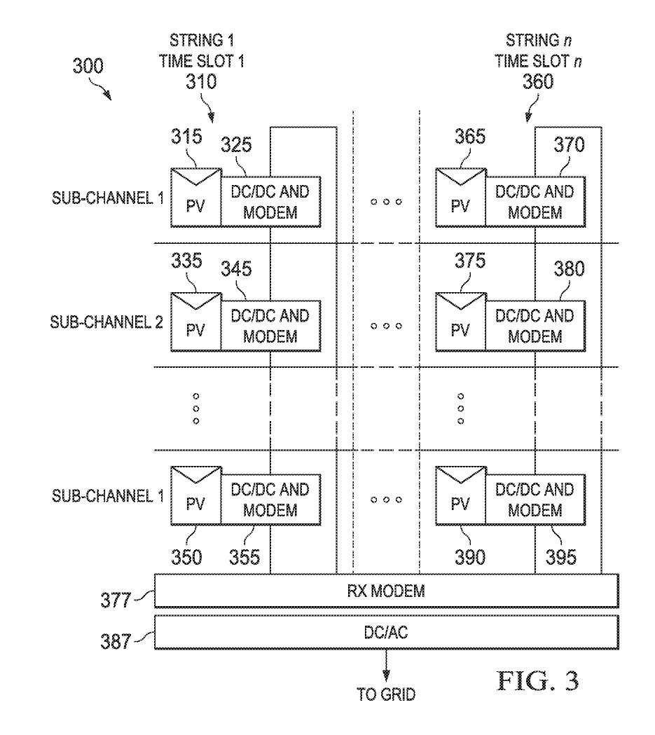

FIG. 3 is a system block diagram of system 300 of power line transmission of solar panel data. A PV module array is divided into two strings, string 1 310 and string n 360. Each string is assigned to a particular time slot. String 1 310 comprises PV module 315, PV module 335, and PV module 350. String n 360 comprises PV module 365, PV module 375, and PV module 390. Each PV module has an associated DC/DC converter and modem. PV module 315 has associated DC/DC converter and modem 325. PV module 335 has associated DC/DC converter and modem 345. PV module 350 has associated DC/DC converter and modem 355. PV module 365 has associated DC/DC converter and modem 370. PV module 375 has an associated DC/DC converter and modem 380. PV module 390 has associated DC/DC converter and modem 395. In an example embodiment, the DC/DC converter implements level shifting of the data from the PV module.

In an example embodiment, the modem is a separate entity from the DC/DC converter. The DC/DC converter performs power conversion in order to equalize the current flowing through all modules in a string. The modem modulates the power-line carrier signal to encode information that needs to be communicated. Each of the modems sends the information in its time slot to receive modem 377. Receive modem 377 assembles each of the time slots in the OFDMA configuration. DC/AC inverter 387 then takes the information modulated on a DC signal and inverts the signal to an AC signal. The modulated AC signal is then applied to the power line which is then sent to the grid. In an example embodiment, DC/AC inverter 387 converts the DC power supplied by the solar modules to AC power that is supplied to the utility grid. Modem 377 is included at the DC/AC inverter 387 that recovers the information content encoded by the various modems (for example, modems 345, 355, etc.) from the modulated power-line carrier signal.

FIG. 4 provides flow diagram 400 of a method of solar panel data power line transmission. In block 410, the PV modules are divided into strings. In block 420, a spectrum of frequencies is divided into sub channels. In block 430, each string is assigned to a time slot. In block 440, each PV module of a string sends data on a different sub channel during an assigned time slot.

Although the present invention has been described in detail, it should be understood that various changes, substitutions and alterations can be made thereto without departing from the spirit and scope of the invention as defined by the appended claims.

Therefore, at least the following is claimed:

1. A system comprising:
a plurality of photovoltaic (PV) modules configured into at least one string of modules, each string of modules assigned to a timeslot in a transmission scheme, each module of each string of modules assigned to a subchannel in a spectrum of frequencies; and
at least one modem configured to communicate data related to at least on of the modules of the plurality of PV modules on a power line.

2. The system of claim 1, wherein the subchannels are selected to be orthogonal to each other.

3. The system of claim 1, wherein the data comprises at least one of voltage, current, module tilt, air temperature, module temperature, and insolation.

4. The system of claim 1, further comprising at least one DC/DC converter configured to level shift the DC voltage of the data.

5. The system of claim 1, further comprising a modem configured to receive the data in each channel for a time slot and to prepare the data for transmission.

6. The system of claim 5, further comprising a DC/AC inverter configured to convert the data for transmission into an AC signal for transmission on the power line.

7. The system of claim 1, further comprising a base station configured to receive the AC signal for data collection.

8. A method comprising:
dividing a plurality of photovoltaic (PV) modules into at least one string of modules;
dividing a spectrum of frequencies into subchannels; and
assigning each string into a timeslot; and sending data related to at least one of the plurality of PV modules on a subchannel during the assigned timeslot.

9. The method of claim 8, further comprising selecting the subchannels to be orthogonal to each other.

10. The method of claim 8, wherein the data comprises at least one of voltage, current, module tilt, air temperature, module temperature, and insolation.

11. The method of claim 10, further comprising at least one DC/DC converter configured to level shift the DC voltage of the data.

12. The method of claim 8, further comprising receiving the data in a modem configured to receive the data in each channel for a time slot and to prepare the data for transmission.

13. The method of claim 12, further comprising converting the data for transmission into an AC signal with a DC/AC inverter for transmission on the power line.

14. The method of claim 8, wherein the dividing the spectrum of frequencies into subchannels comprises at least one of a statically allocating the subchannels and dynamically allocating the subchannels.

15. A system, comprising:
means for dividing a plurality of photovoltaic (PV) modules into at least one string of modules;
means for dividing a spectrum of frequencies into subchannels; and
means for assigning each string into a timeslot; and sending data related to at least one of the plurality of PV modules on a subchannel during the assigned timeslot.

16. The system of claim 15, further comprising means for selecting the subchannels to be orthogonal to each other.

17. The system of claim 15, wherein the data comprises at least one of voltage, current, module tilt, air temperature, module temperature, and insolation.

18. The system of claim 15, further comprising means for level shifting the DC voltage of the data.

19. The system of claim 15, further comprising means for receiving the data in a modem, to receive the data in each channel for a time slot, and to prepare the data for transmission.

20. The system of claim 19, further comprising means for converting the data for transmission into an AC signal with a DC/AC inverter for transmission on the power line.
